(19) United States
(12) Patent Application Publication
(10) Pub. No.: US 2011/0206946 A1
(43) Pub. Date: Aug. 25, 2011

(54) METHOD FOR PRODUCING A CARBON NANOTUBE-, FULLERENE- AND/OR GRAPHENE-CONTAINING COATING

(75) Inventors: Helge Schmidt, Speyer (DE); Isabell Buresch, Illertissen (DE); Udo Adler, Koblenz (DE); Dirk Rode, Osnabruck (DE); Sonja Priggemeyer, Wallenhorst (DE)

(73) Assignees: KME GERMANY AG & CO. KG, 49074 Osnabruck (DE); TYCO ELECTRONICS AMP GMBH, 64625 Bensheim (DE); WIELAND-WERKE AKTIENGESELLSCHAFT, 89079 Ulm (DE)

(21) Appl. No.: 13/125,236

(22) PCT Filed: Sep. 3, 2009
(86) PCT No.: PCT/DE2009/001237

§ 371 Date: Apr. 20, 2011

(30) Foreign Application Priority Data
Oct. 24, 2008 (DE) 10 2008 053 027.1

(51) Int. Cl. B32B 15/01; B05D 5/00; B05D 3/12; B05D 1/36; B05D 1/38; B05D 3/02; B05D 1/28; B82Y 30/00

(52) U.S. Cl. 428/646; 427/180; 427/201; 427/355; 977/750; 977/752; 977/734

(57) ABSTRACT

A method for producing a carbon nanotube-, fullerene- and/or graphene-containing coating on a substrate includes the steps of applying carbon nanotubes, fullerenes and/or graphenes onto a tin-containing coating and introducing carbon nanotubes, fullerenes and/or graphenes into the coating by mechanical and/or thermal treatment. A coated substrate produced by this method and the use of the coated substrate as an electromechanical component or lead frame are also described.

The invention relates to a method for producing a carbon nanotube-, fullerene- and/or graphene-containing coating on a substrate, which includes deposition of carbon nanotubes, fullerenes and/or graphenes on a tin-containing coating and introduction of carbon nanotubes, fullerenes and/or graphenes into the coating by mechanical or thermal treatment. The invention also relates to a substrate coated with the method according to the invention and use of the coated substrate as an electromechanical component.

Carbon nanotubes (CNTs) were discovered by Sumio Iijama in 1991 (see S. Iijama, Nature, 1991, 354, 56). Iijama discovered in the soot of a fullerene generator under certain reaction conditions tube-like structures with a diameter of only several 10 nm, but with a length of several micrometers. The discovered compounds consisted of several concentric graphite tubes which acquired the designation multi-wall carbon nanotubes (MWCNTs). Shortly thereafter, single-wall CNTs with a diameter of only approximately 1 nm were discovered by Iijama and Ichihashi, which were designated accordingly as single-wall carbon nanotubes (SWCNTs) (see S. Iijama, T. Ichihashi, Nature, 1993, 363, 6430).

Several outstanding properties of CNTs are, for example, their mechanical tensile strength and stiffness of about 40 GPa and 1 TPa, respectively (20 times and 5 times greater than that of steel).

CNTs exist as both conducting and semiconducting materials. The carbon nanotubes are part of the family of fullerenes and have a diameter of 1 nm to several 100 nm. Carbon nanotubes are microscopically small tubular structures (molecular nanotubes) made of carbon. Their walls consist, like those of fullerenes or like the planes of graphite, only of carbon, whereby the carbon atoms have a honeycomb-like structure with six corners, with each carbon atom having three binding partners (determined by the sp²-hybridization). The diameter of the tubes is mostly in a range between 1 and 50 nm, whereby tubes with only 0.4 nm diameter have also been produced. Lengths of several millimeters for individual tubes and of up to 20 cm for tube bundles have already been achieved.

The synthesis of the carbon nanotubes occurs typically by precipitation of carbon from the gas phase or from a plasma. In particular, the current-carrying capacity and the thermal conductivity are of interest to the electronics industry. The current-carrying capacity is approximately 1000 times greater than that of copper wires, the thermal conductivity at room temperature is with 6000 W/m*K approximately twice that of diamond, the best naturally occurring thermal conductor.

It is known in the art to mix carbon nanotubes with conventional plastic. The mechanical properties of the plastic material are thereby significantly improved. In addition, electrically conducting plastics can be produced; for example, nanotubes have already been used for rendering antistatic foils conductive.

As already mentioned above, the carbon nanotubes belong to the group of the fullerenes. Spherical molecules of carbon atoms with a high symmetry are referred to as fullerenes which represent the third elemental modification of carbon (in addition to diamond and graphite). The fullerenes are typically produced by evaporating graphite under reduced pressure and in an inert gas atmosphere (e.g. argon) using resistance heating or in an electric arc. The aforedescribed carbon nanotubes are frequently produced as a byproduct. Fullerenes have from semiconducting to superconducting properties.

Graphenes refer to monatomic layers of sp²-hybridized carbon atoms. Graphenes have very high electrical and thermal conductivity along their plane. Graphenes are prepared by separating graphite into its basal planes. Initially, oxygen is intercalated. The oxygen partially reacts with the carbon and causes mutual repulsion of the layers. The graphenes are then suspended and embedded, depending on the application, for example in polymers.

Another possibility for preparing individual graphene layers involves heating hexagonal silicon carbide surfaces to temperatures above 1400° C. Due to the higher vapor pressure of silicon, the silicon atoms evaporate faster than the carbon atoms. Thin layers of single-crystalline graphite consisting of several graphene monolayers are then formed on the surface.

Tin or tin alloys are typically used for soldering electrical contacts, for example for interconnecting copper wires. Tin or tin alloys are frequently also applied to plug connectors for improving the friction value, for protection against corrosion and for also improving the conductivity. A problem with tin or tin alloys is in particular the softness of the metal or alloy, so that the tin-containing coating is worn down in particular after frequent disconnection and reconnection of plug connectors and in the presence of vibrations, so that the advantages of the tin-containing coating are lost.

It was therefore an object of the present invention to provide a coating made of a tin-containing material which has a lesser tendency to wear and/or improved friction corrosion properties while at the same time ensuring that properties relating to friction value, conductivity and the like are maintained or improved.

The object is attained by a method for producing a coating containing carbon nanotubes, fullerenes and/or graphenes, which includes deposition of carbon nanotubes, a fullerenes and/or graphenes on a tin-containing coating and introducing the carbon nanotubes, fullerenes and/or graphenes into the coating through mechanical or thermal treatment.

The substrate on which the tin-containing coating is disposed is preferably a metal, particularly preferred are copper and its alloys. Advantageously, at least one additional intermediate layer may be deposited between the tin-containing coating and the substrate.

Preferably, tin or a tin alloy is used as tin-containing coating on the substrate. Carbon nanotubes, fullerenes and/or graphenes are deposited on or introduced into the tin alloy, wherein, the coating metal may be solid, liquid or paste-like during the deposition or introduction of the carbon nanotubes, fullerenes and/or graphenes.

Preferably, mechanical pressure is applied on the carbon nanotubes, fullerenes and/or graphenes with a roller, a stamp, mechanical brushes, by spraying or blowing. In the context of the present invention, spraying and blowing is to be understood as applying mechanical pressure.

The tin-containing coating may be in solid form (meaning in a solid state of aggregation) when the carbon nanotubes, fullerenes and/or graphenes are deposited, whereas the carbon nanotubes, fullerenes and/or graphenes can be introduced into the coating by applying mechanical pressure on the carbon nanotubes, fullerenes and/or graphenes with a roller, a stamp or with mechanical brushes.

However, the coating may also be in liquid or paste-like form when the carbon nanotubes, fullerenes and/or graphenes are deposited, wherein the carbon nanotubes, fullerenes and/or graphenes are introduced into the coating/coating metal by applying mechanical pressure on the carbon nanotubes, fullerenes and/or graphenes with a roller, a stamp, mechanical brushes, by spraying or blowing. If the coating is a liquid, then the temperature at which the carbon nanotubes, fullerenes and/or graphenes are introduced may be below the melting temperature of the coating, so that the carbon nanotubes, fullerenes and/or graphenes are fixed in the layer.

As already mentioned above, the carbon nanotubes, fullerenes and/or graphenes can also be thermally introduced into the coating. This thermal treatment includes heating the coating to a temperature below or above the melting point of the coating. Heating to a temperature below the melting point of the coating results in a paste-like state, whereas heating to a temperature above the melting point of the coating results in a liquid state of the coating.

In one embodiment, the coating is solid when the carbon nanotubes, fullerenes and/or graphenes are deposited and is subsequently heated to a temperature above the melting point of the coating. The carbon nanotubes, fullerenes and/or graphenes then melt into the coating layer and can be fixed by cooling the coating material below the melting point.

According to another embodiment of the present invention, the coating is liquid when the carbon nanotubes, fullerenes and/or graphenes are deposited and is subsequently brought to a temperature below the melting point of the coating, whereby the carbon nanotubes, fullerenes and/or graphenes that entered the coating are fixed.

According to another embodiment, the coating is solid when the carbon nanotubes, fullerenes and/or graphenes are deposited and is subsequently heated to a temperature below the melting point of the coating. This process is equivalent to annealing, whereby due to the attained paste-like state of the coating the carbon nanotubes, fullerenes and/or graphenes migrate slowly into the coating material.

In all embodiments, the carbon nanotubes, fullerenes and/or graphenes are preferably deposited on the coating and/or the carbon nanotubes, fullerenes and/or graphenes are introduced into the coating in a normal atmosphere or in an inert gas. Normal atmosphere in the context of the present invention refers to normal ambient air. An inert gas can be any conventional gas that provides an oxygen-free atmosphere. It is known to use, for example, nitrogen or argon.

In the method according to the invention, nanotubes in form of single-wall or multi-wall carbon nanotubes can be used as a powder or dispersed in a suspension.

According to another preferred embodiment, the carbon nanotubes, fullerenes and/or graphenes can be provided with an encapsulation made of a metal before being deposited onto the coating. The encapsulation can be applied by mechanical kneading with a metal. For example, a ball mill or an extruder can be used for the mechanical kneading. The encapsulation can also be applied chemically on the carbon nanotubes, fullerenes and/or graphenes, for example by depositing a metal salt solution which is subsequently reduced, or by depositing a metal oxide which is subsequently reduced.

According to another preferred embodiment, the carbon nanotubes, fullerenes and/or graphenes may be supplied to the metal strip in a Sn(-alloy) melt in form of a dispersion using ultrasound and applied with a roller followed by mechanical stripping.

Within the context of the invention, the carbon nanotubes, fullerenes and/or graphenes preferably form a composite with one another, i.e., they are connected with one another. In a particularly preferred embodiment, a graphene is arranged on the axial end of a carbon nanotube. Electrical and thermal conductivity in a horizontal and vertical direction can thereby be attained. The mechanical load-carrying capacity also increases in the horizontal and vertical direction.

Another object of the invention is a coated substrate produced with the method according to the invention. Preferably, the substrate is copper or a copper-containing alloy or includes copper or a copper-containing alloy, or Al or an Al-containing alloy, or Fe or a Fe-containing alloy. Advantageously, intermediate layers may be deposited between the tin-containing coating and the substrate.

The substrate coated according to the invention is superbly suited as an electromechanical component or lead frame, for example as switching element, plug connector and the like.

1-20. (canceled)

21. A method for producing a coating containing carbon nanotubes, fullerenes and/or graphenes on a substrate, comprising the steps of depositing carbon nanotubes, fullerenes and/or graphenes on a tin-containing coating and introducing the carbon nanotubes, fullerenes and/or graphenes into the tin-containing coating by mechanical and/or thermal treatment.

22. The method of claim 21, wherein the tin-containing coating comprises tin or a tin alloy.

23. The method of claim 21, wherein the tin-containing coating is in solid, liquid or paste-like form when the carbon nanotubes, fullerenes and/or graphenes are deposited.

24. The method of claim 21, wherein the mechanical treatment includes applying mechanical pressure onto the carbon nanotubes, fullerenes and/or graphenes.

25. The method of claim 24, wherein the mechanical pressure is applied to the carbon nanotubes, fullerenes and/or graphenes with a roller, with a stamp, with mechanical brushes, by spraying or by blowing.

26. The method of claim 23, wherein the coating is in solid form when the carbon nanotubes, fullerenes and/or graphenes are deposited and the carbon nanotubes, fullerenes and/or graphenes are introduced into the tin-containing coating through application of mechanical pressure to the carbon nanotubes, fullerenes and/or graphenes with a roller, with a stamp or with mechanical brushes.

27. The method of claim 23, wherein the tin-containing coating is in liquid or paste-like form when the carbon nanotubes, fullerenes and/or graphenes are deposited and the carbon nanotubes, fullerenes and/or graphenes are introduced into the tin-containing coating through application of mechanical pressure to the carbon nanotubes, fullerenes and/or graphenes with a roller, with a stamp, with mechanical brushes, by spraying or by blowing.

28. The method of claim 21, wherein the thermal treatment comprises heating the tin-containing coating to a temperature below or above the melting point of the tin-containing coating.

29. The method of claim 28, wherein the tin-containing coating is solid when the carbon nanotubes, fullerenes and/or graphenes are deposited and is subsequently heated to a temperature above the melting point of the tin-containing coating.

30. The method of claim 28, wherein the tin-containing coating is liquid when the carbon nanotubes, fullerenes and/or graphenes are deposited and is subsequently brought to a temperature below the melting point of the tin-containing coating.

31. The method of claim 28, wherein the tin-containing coating is solid when the carbon nanotubes, fullerenes and/or graphenes are deposited and is subsequently heated to a temperature below the melting point of the tin-containing coating.

32. The method of claim 21, wherein the carbon nanotubes, fullerenes and/or graphenes are deposited on the tin-containing coating and/or the carbon nanotubes, fullerenes and/or graphenes are introduced into the tin-containing coating in a normal atmosphere or in an inert gas.

33. The method of claim 21, wherein the carbon nanotubes comprise single-wall or multi-wall carbon nanotubes.

34. The method of claim 21, further comprising the step of encapsulating the carbon nanotubes, fullerenes and/or graphenes in a metal before depositing the carbon nanotubes, fullerenes and/or graphenes on the tin-containing coating.

35. The method of claim 34, wherein encapsulating is performed by mechanical kneading of the carbon nanotubes, fullerenes and/or graphenes with the metal, or chemically.

36. The method of claim 21, further comprising the step of dispersing the carbon nanotubes, fullerenes and/or graphenes with ultrasound in a tin-containing metallic melt before depositing the carbon nanotubes, fullerenes and/or graphenes on the substrate with a roller followed by mechanical stripping for adjusting a predetermined layer thickness of the carbon nanotubes, fullerenes and/or graphenes.

37. The method of claim 21, wherein the substrate is made of copper or a copper-containing alloy, of aluminum or an aluminum-containing alloy, or of iron or an iron-containing alloy.

38. The method of claim 21, further comprising the step of depositing on the substrate at least one intermediate layer, wherein the intermediate layer is arranged between the substrate and the tin-containing coating.

39. A composite structure comprising:
a substrate made of copper or a copper-containing alloy, aluminum or an aluminum-containing alloy, or iron or an iron-containing alloy,
a tin-containing coating deposited in the substrate, and
carbon nanotubes, fullerenes and/or graphenes introduced into the tin-containing coating by mechanical and/or thermal treatment.

40. The composite structure of claim 39, further comprising at least one intermediate layer arranged between the substrate and the tin-containing coating.

41. An electromechanical component or lead frame comprising a composite structure with
a substrate made of copper or a copper-containing alloy, aluminum or an aluminum-containing alloy, or iron or an iron-containing alloy,
a tin-containing coating deposited in the substrate, and
carbon nanotubes, fullerenes and/or graphenes introduced into the tin-containing coating by mechanical and/or thermal treatment.
